(19) United States
(12) Patent Application Publication
(10) Pub. No.: US 2025/0151044 A1
(43) Pub. Date: May 8, 2025

(54) SYSTEMS AND METHODS FOR TDD CONFIGURATIONS FOR SMART NODES

(71) Applicant: ZTE CORPORATION, Shenzhen (CN)

(72) Inventors: Hanqing XU, Shenzhen (CN); Nan ZHANG, Shenzhen (CN); Ziyang LI, Shenzhen (CN); Wei CAO, Shenzhen (CN); Shuang ZHENG, Shenzhen (CN)

(73) Assignee: ZTE CORPORATION, Shenzhen (CN)

(21) Appl. No.: 19/019,022

(22) Filed: Jan. 13, 2025

Related U.S. Application Data
(63) Continuation of application No. PCT/CN2022/129859, filed on Nov. 4, 2022.

(51) Int. Cl. H04W 72/0453; H04L 5/14; H04W 72/23

(52) U.S. Cl. CPC H04W 72/0453; H04L 5/14; H04W 72/23

(57) ABSTRACT

Presented are systems and methods for time division duplex (TDD) configurations for smart nodes. A network node can receive a message from a wireless communication node for a link communicatively coupled between the network node and the wireless communication node or between the network node and a wireless communication device. The message can comprise first information indicating one or more of Time Division Duplex (TDD) configurations for the link and/or second information indicating one or more carriers for the link.

### CROSS-REFERENCE TO RELATED APPLICATION

This application claims the benefit of priority under 35 U.S.C. § 120 as a continuation of PCT Patent Application No. PCT/CN2022/129859, filed on Nov. 4, 2022, the disclosure of which is incorporated herein by reference in its entirety.

### TECHNICAL FIELD

The disclosure relates generally to wireless communications, including but not limited to systems and methods for time division duplex (TDD) configurations for smart nodes.

### BACKGROUND

Coverage is a fundamental aspect of cellular network deployments. Mobile operators rely on different types of network nodes to offer blanket coverage in their deployments. As a result, new types of network nodes have been considered to increase the flexibility of mobile operators for their network deployments. For example, certain systems or architecture introduce integrated access and backhaul (IAB), which may be enhanced in certain other systems, as a new type of network node not requiring a wired backhaul. Another type of network node is the RF repeater which simply amplify-and-forward any signal that they receive. RF repeaters have seen a wide range of deployments in 2G, 3G and 4G to supplement the coverage provided by regular full-stack cells.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A network node (e.g., smart node (SN)) can receive a message from a wireless communication node (e.g., base station (BS), gNB, or transmission and reception point (TRP)) for a link communicatively coupled between the network node and the wireless communication node or between the network node and a wireless communication device (e.g., user equipment (UE)). The message can include first information indicating one or more of Time Division Duplex (TDD) configurations for the link and/or second information indicating one or more carriers for the link.

In some implementations, the link can include at least one of following links: a first forwarding link from the wireless communication node to the network node; a second forwarding link from the network node to the wireless communication node; a third forwarding link from the network node to the wireless communication device; a fourth forwarding link from the wireless communication device to the network node; a first control link from the wireless communication node to the network node; and/or a second communication link from the network node to the wireless communication node.

In some implementations, the message can be received through a Radio Resource Control (RRC) signaling. In some implementations, the RRC signaling can include a new RRC signaling or a legacy RRC signaling. In some implementations, the message can be received through at least one of a medium access control control element (MAC CE) signaling or a Downlink Control Information (DCI) signaling. In some implementations, the DCI signaling includes a single DCI signaling or multiple DCI signalings.

In some implementations, the message can be received through a first type of DCI signaling and a second type of DCI signaling that correspond to a first format and a second format, respectively. In some implementations, the first format, associated with a first unit of the network node, can reuse a legacy DCI format with cyclic redundancy check (CRC) scrambled by a Slot Format Indicator-Radio Network Temporary Identifier (SFI-RNTI). The second format, associated with a second unit of the network node, can reuse the legacy DCI format with CRC scrambled by a new RNTI.

In some implementations, the first format, associated with a first unit of the network node, can reuse a legacy DCI format with cyclic redundancy check (CRC) scrambled by a Slot Format Indicator-Radio Network Temporary Identifier (SFI-RNTI). The second format, associated with a second unit of the network node, can have a new DCI format with CRC scrambled by a new RNTI.

In some implementations, the first format, associated with a first unit of the network node, can reuse a legacy DCI format with cyclic redundancy check (CRC) scrambled by a first new RNTI. The second format, associated with a second unit of the network node, can reuse the legacy DCI format with CRC scrambled by a second new RNTI.

In some implementations, the first format, associated with a first unit of the network node, can reuse a legacy DCI format with cyclic redundancy check (CRC) scrambled by a first new RNTI. The second format, associated with a second unit of the network node, can have a new DCI format with CRC scrambled by a second new RNTI.

In some implementations, first format, associated with a first unit of the network node, can have a first new DCI format with cyclic redundancy check (CRC) scrambled by a first new RNTI. The second format, associated with a second unit of the network node, can have a second new DCI format with CRC scrambled by a second new RNTI. In some implementations, the legacy DCI format can be DCI format 2_0.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a schematic diagram of an example network, in accordance with some embodiments of the present disclosure;

FIG. 4 illustrates a schematic diagram of transmission links between BS to SN and SN to UE, in accordance with some embodiments of the present disclosure;

FIG. 5 illustrates an example of an SN communication unit (CU) and SN forwarding unit (FU) in the same frequency band, in accordance with some embodiments of the present disclosure; and

FIG. 6 illustrates a flow diagram of an example method for TDD configurations for SN, in accordance with an embodiment of the present disclosure.

### DETAILED DESCRIPTION

### 1. Mobile Communication Technology and Environment

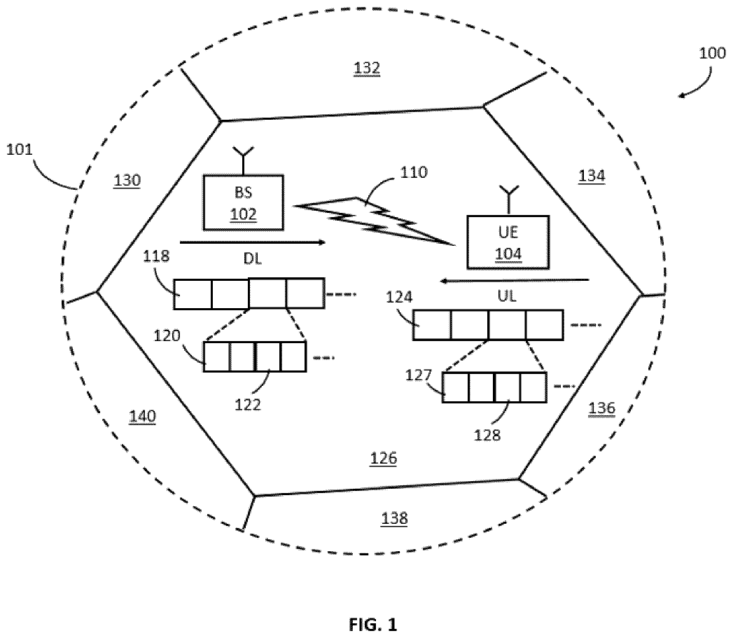

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

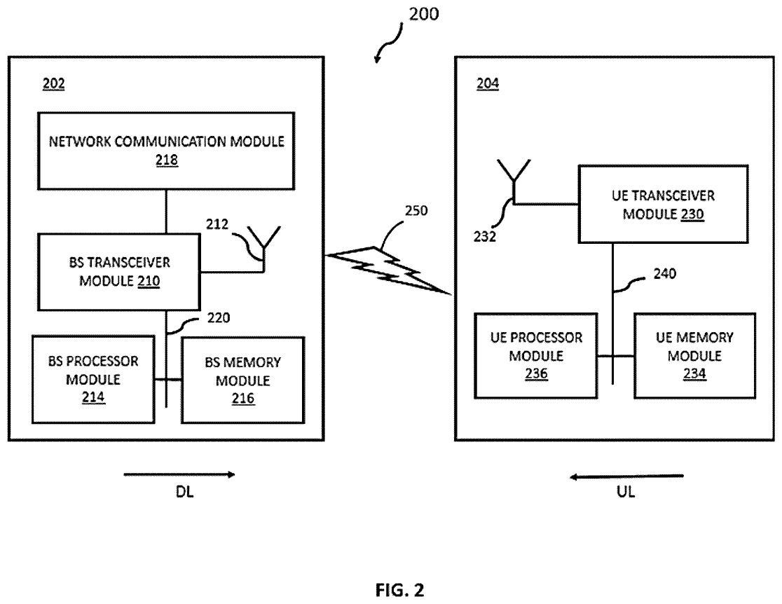

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communicate with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Time Division Duplex (TDD) Configurations for Smart Nodes

In certain systems (e.g., 5G new radio (NR), Next Generation (NG) systems, 3GPP systems, and/or other systems), a network-controlled repeater (NCR) can be introduced as an enhancement over conventional RF repeaters with the capability to receive and/or process side control information from the network. Side control information can allow a network-controlled repeater to perform/execute/operate its amplify-and-forward operation in a more efficient manner. Certain benefits can include at least mitigation of unnecessary noise amplification, transmissions and receptions with better spatial directivity, and/or simplified network integration.

The NCR can be regarded as a steppingstone of a re-configurable intelligent surface (RIS). A RIS node can adjust the phase and amplitude of the received signal to improve/enhance the coverage (e.g., network communication coverage). As discussed herein, network nodes, including and not limited to network-controlled repeater, smart repeater, enhanced RF repeaters, re-configuration intelligent surface (RIS), and/or integrated access and backhaul (IAB), can be denoted, referred to, or provided as a smart node (SN) (e.g., network node) for simplicity. For example, the SN can include, correspond to, or refer to a kind of network node to assist the BS 102 to improve coverage (e.g., avoiding/averting blockage/obstructions, increasing transmission range, etc.).

In certain cases, when SN communication unit (CU) and SN forwarding unit (FU) of the SN are in the same frequency band and/or in the same carrier, a similar TDD UL/DL configuration can be used/assumed/configured for C-link and backhaul/access link. In this case, the SN CU can acquire/receive/obtain the TDD configuration as legacy UEs (e.g., method for SN CU acquiring the TDD configuration may be the same as a legacy UE) and/or from an administration and maintenance (OAM). Subsequently, the same TDD configuration may be used for the backhaul/access link. Because the same TDD configuration is used, new/additional signaling for indicating the TDD configuration of backhaul/access link may not be desired. However, in certain scenarios, the carrier of the SN CU may not be the same as the carrier for the SN FU and/or one or more carriers of/within the set of carriers of the SN FU. In these scenarios, the TDD configuration of the SN CU carrier may not apply to, be configured for, or be used for the SN FU carrier(s). Hence, it may be desired to obtain TDD uplink (UL) and/or downlink (DL) configuration in each carrier of the SN FU. The systems and methods of the technical solution can perform features, operations, techniques, and/or methods discussed herein to obtain the TDD UL/DL configuration in each carrier of the SN FU, such as for communicative coupling between the SN and the BS 102 and/or the SN and the UE 104.

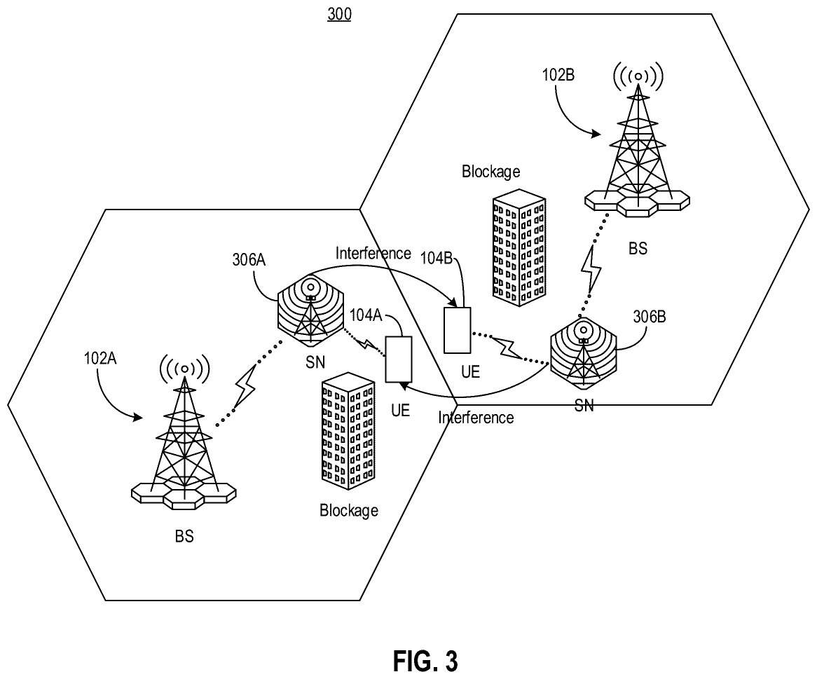

FIG. 3 illustrates a schematic diagram of an example network 300. As illustrated in FIG. 3, one or more BSs 102A-B (e.g., BSs 102) can serve one or more UEs 104A-B (e.g., UEs 104) respectively in their cells via the respective one or more SNs 306A-B (e.g., sometimes labeled as SN(s) 306), such as when there are blockages between the BS(s) 102 and the UE(s) 104.

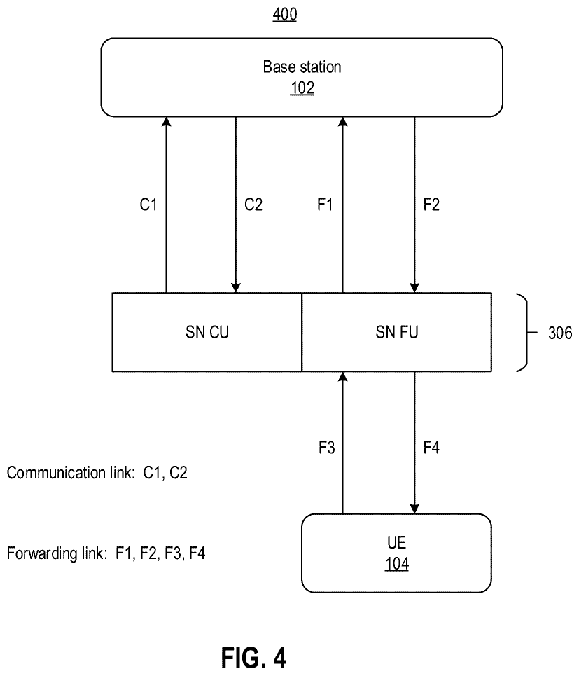

FIG. 4 illustrates a schematic diagram 400 of transmission links between BS 102 to SN 306 and SN 306 to UE 104. The SN 306 can include or consist of at least two units or functional parts/components (e.g., sometimes referred to as function entities), such as the communication unit (CU) (e.g., SN CU) and the forwarding unit (FU) (e.g., SN FU). The units of the SN 306 can support different functions for communication with at least one of the BS 102 and/or the UE 104. A first unit (or function entity) of the SN 306 may refer to the SN CU and a second unit (or function entity) of the SN 306 may refer to the SN FU or vice versa, in some cases. For example, the SN CU (e.g., first unit) can be a network-controlled repeater (NCR) MT. In another example, the SN FU (e.g., second unit) can be an NCR forwarder/forwarding (Fwd). The SN CU can act/behave or include features similar to a UE 104, for instance, to receive and decode side control information from the BS 102. The SN CU may be a control unit, controller, mobile terminal (MT), part of a UE, a third-party IoT device, and so on. The SN FU can carry out the intelligent amplify-and-forward operation using the side control information received by the SN CU. The SN FU may be a radio unit (RU), a RIS, and so on.

The transmission links between the BS 102 to SN 306 and the SN 306 to UE 104 as shown in FIG. 4 can be defined/described/provided as follows:
C1: Control link (C-link) from SN CU to BS;
C2: Control link (C-link) from BS to SN CU;
F1: Backhaul link from SN FU to BS;
F2: Backhaul link from BS to SN FU;
F3: Access link from UE to SN FU; and
F4: Access link from SN FU to UE.

Control link (e.g., sometimes referred to as a communication link) can refer to or mean that the signal from one side will be detected and decoded by the other side, so that the information transmitting in the control link can be utilized to control the status of forwarding links (e.g., backhaul links and/or access links, F-link). Forwarding link can mean that the signal from BS 102 or UE 104 is unknown to SN FU. In this case, the SN FU can amplify and forward signals without decoding them. For example, the F1 and F3 links can correspond to or be associated with the complete uplink (UL) forwarding link (e.g., backhaul link and access link, respectively) from UE 104 to BS 102, in which F1 is the SN FU UL forwarding link. Additionally, the F2 and F4 links can correspond to or be associated with the complete DL forwarding link (e.g., backhaul link and access link, respectively) from BS 102 to UE 104, in which F4 is the SN FU DL forwarding link. The F1 and F2 links can correspond to or be referred to as backhaul links and F3 and F4 links can correspond to or be referred to as access links.

### Example Implementation 1

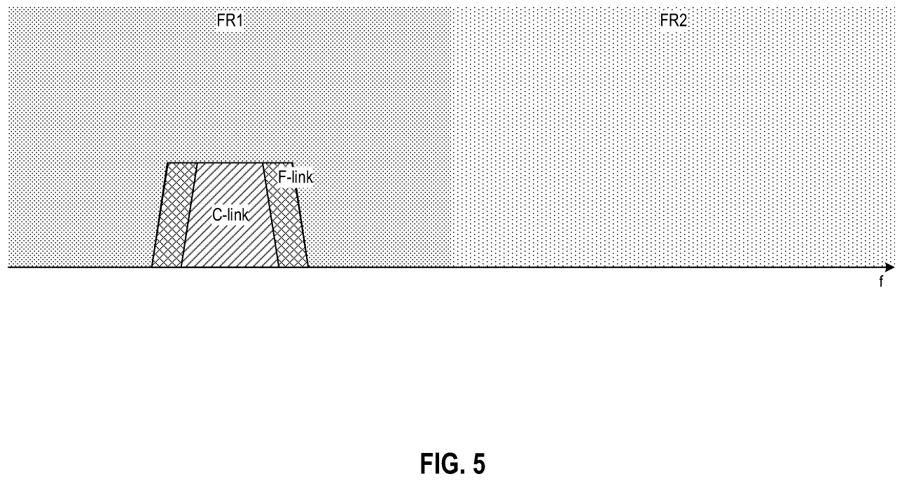

Referring to FIG. 5, depicted is an example 500 of the SN CU and the SN FU in the same frequency band. In some cases, when the SN CU and SN FU are in the same frequency band (e.g., F1 in this case) and/or in the same carrier, the same TDD UL/DL configuration can be assumed/applied/used for C-link and backhaul/access link (e.g., F-link). SN CU can acquire/obtain/receive the TDD configuration as legacy UEs and/or from the OAM. The same TDD configuration of the SN CU (e.g., C-link) can be assumed for the SN FU (e.g., backhaul/access link or F-link). In this case, no new/additional signal is desired for indicating the TDD configuration of the F-link. However, in scenarios where the SN CU carrier and the SN FU carrier (e.g., one or more carriers in a set of SN FU carriers) are different, the TDD configuration of the SN carrier may not be applied/used/configured for the SN FU carrier(s). Hence, the systems and methods of the technical solution discussed herein can obtain TDD UL/DL configuration for each carrier of the SN FU to establish communication between the SN 306 and the BS 102 and/or the SN 306 and the UE 104, among other network entities, for example.

In various arrangements, the SN (e.g., network node, SN CU) can report/notify/provide/indicate the capabilities of at least one of the new radio (NR), LTE bands, carriers supported by the SN FU and/or SN CU, among other information to the BS 102 (e.g., eNB, gNB, wireless communication node, or TRP). The capabilities can include at least one of the supported NR/LTE frequency band number(s) (e.g., NR frequency band number and/or the LTE frequency band number may be specified in the specification), band combination, bandwidth (or aggregated bandwidth), the number of supported carriers, etc. In some cases, the capabilities may be divided into DL and UL capabilities.

In some implementations, the SN 306 can report the capabilities of the SN CU and SN FU independently to the BS 102, e.g., the parameters of the capabilities of SN CU and SN FU can be separately provided/defined/set. The BS 102 may transmit/send/provide/signal the information of one or more TDD UL/DL configurations associated with or corresponding to one or more carriers to the SN 306 (e.g., SN CU). The SN 306 (e.g., SN CU) can receive the information from the BS 102. This information from the BS 102 may include at least one of the information of TDD UL/DL configuration and/or information of corresponding carriers. The SN 306 can use the TDD UL/DL configurations to determine the direction of slots/symbols (e.g., downlink, uplink, and/or flexible) at the side of SN FU and/or SN CU. The above capabilities of the SN 306 (e.g., SN CU and/or SN FU) may be informed/provided to the BS 102 by the OAM (e.g., OAM connection). In some cases, the term “flexible” may refer to a symbol that is not configured as DL or UL, and/or the direction of the symbols is not determined/defined/clarified.

In some implementations, the BS 102 may transmit beam information, on/off information, power control information, and/or timing information, among other information associated with or corresponding to one or more carriers to the SN 306 (e.g., SN CU). In some cases, additional or alternative information from the TDD information may be provided to perform similar features or functionalities discussed herein, such as determining the direction of the slots/symbols and/or providing carrier information to the SN 306 (e.g., SN CU). The term “carrier” may be used interchangeably or replaced with other similar terms (e.g., similar meanings), such as passband, frequency band, sub-band, cell or serving cell, channel, etc.

In various implementations, the information of the TDD UL/DL configuration can include at least one of the following: periodicity (e.g., DL/UL transmission periodicity), (e.g., reference) sub-carrier spacing, the number of DL slots/symbols, the number of UL slots/symbols, the set of slot configurations, slot index, indication of a DL/UL slot (e.g., symbols in the slot may be DL and/or UL symbols), start and/or length, bitmap for indicating DL/UL/flexible symbols/slots, the direction in the flexible symbols, and/or the SN behavior/characteristic in the flexible symbols, among others.

The information of the carrier can include at least one of the following: carrier index, carrier group index (e.g., a carrier group including or consisting of multiple carriers), NR frequency band number (e.g., specified in the specification), the frequency of the carrier or the carrier group or NR frequency band (e.g., central frequency, absolute radio frequency channel number (ARFCN), start/end frequency, and/or bandwidth), etc. The relationship/connection/association between TDD UL/DL configuration and the carrier can include at least one of the following:
One TDD configuration may be associated with or correspond to one carrier and/or one carrier group, such as TDD configuration 1 for carrier 1, TDD configuration 2 for carrier 2, TDD configuration 3 for carrier 3, and so on.
One TDD configuration may be associated with or correspond to multiple carriers or multiple carrier groups, such as TDD configuration 1 for carriers 1 and 2, TDD configuration 1 for carriers 3 and 4, and so on.
Multiple TDD configurations may be associated with or corresponding to one carrier, such as TDD configurations 1 and 2 for carrier 1, TDD configurations 3 and 4 for carrier 2, and so on.

The information on the TDD configurations and/or carriers received from the BS 102 can be carried/included/contained via at least one of, but not limited to, the following:
System information (e.g., in SIB1).
RRC signaling.
MAC CE and/or DCI signaling (e.g., DCI format 2_0).

For RRC signaling (e.g., RRC signal carrying the information on the TDD configurations and/or carriers), the BS 102 may use a new RRC signaling and/or reuse a legacy RRC signaling to transmit/send the above information (e.g., information on the TDD configurations) to the SN 306 (e.g., SN CU and/or SN FU). For instance, the BS 102 can use RRC reconfiguration messages/signals to send the information.

In some implementations, the information on the TDD configurations and/or carriers for the SN CU and/or SN FU may be transmitted/transferred/sent from the BS 102 to the SN 306 in separate/individual RRC signalings or in the same RRC signaling. For example, if the information of TDD configurations and/or the carriers for SN CU and/or SN FU is sent in separate RRC signalings for the same carrier configured for the SN CU and the SN FU, the TDD configurations can be the same between the SN CU and SN FU.

The BS 102 can configure/change/adjust the carriers supported by or to be configured for SN FU and/or SN CU as a carrier list/table/metric via a new and/or legacy RRC signaling. The maximum number of carriers in the carrier list may be limited/restricted/capped to the maximum number of carriers supported by SN FU and/or SN CU. In this case, the number of carriers in the carrier list may not exceed the number of supported carriers by the SN FU and/or the SN CU. In some implementations, for each carrier added/provided to the list of carriers, The NR-FU may forward the transmission from the BS 102 or the UE 104 in the carrier, such as in a default configuration of the SN FU (e.g., the default state of SN FU can be “ON”). For each carrier released/removed/deleted and/or not included in the list, the NR-FU may not forward the transmission in the carrier (e.g., the carrier not on the carrier list), such as in a default configuration of the SN FU (e.g., the default state of SN FU can be “OFF”).

In some implementations, for each carrier in this list of carriers, an RRC structure can be designed/generated/implemented. The parameters of the RRC structure can include at least one of the carrier index and/or the parameters of the TDD configuration, among others. The parameters of the TDD configuration can include at least one of ServingCellConfigCommon, tdd-UL-DL-ConfigurationDedicated ServingCellConfig, etc. The TDD configuration for SN FU and/or SN CU can be configured in these two parameters. For instance, the TDD common configuration can be configured in the former parameter (e.g., ServingCellConfigCommon), and/or the TDD dedicated configuration can be configured in the latter parameter (e.g., tdd-UL-DL-ConfigurationDedicated ServingCellConfig).

In some implementations, the MAC CE and/or DCI signal may carry/include/contain the information on the TDD configurations and/or carriers. If the information is indicated by DCI signaling, the information may be scrambled by/mixed/included with at least one of a new SN-specific, link-specific, service-type specific, and/or SN logic unit-specific radio network temporary identifier (RNTI) (e.g. SN CU and/or SN FU-related RNTI).

In scenarios of indicating the information (e.g., TDD configurations and/or carriers information) via the DCI signaling, the BS 102 can configure the carriers supported by or to be configured for the SN FU and/or SN CU as at least a part of a carrier list via a new and/or legacy RRC signaling. The maximum number of carriers in the carrier list may not exceed the maximum number of carriers supported by the SN FU and/or SN CU. In some cases, for each added or existing carrier in the carrier list, the NR-FU may forward data in the carrier, such as by default when the default state of SN FU is “ON”. In some other cases, for each carrier removed/released or not included in the carrier list, the NR-FU may not forward the data in the carrier (e.g., the carrier not on the list), such as by default when the default state of SN FU is “OFF”, for example.

In some implementations, for each carrier in the carrier list, the RRC structure may be designed. The parameters included in this RRC structure may include at least one of the carrier index and/or slot format combinations, among others. The slot format combination can include at least one of carrier index, subcarrier spacing, slot formation combinations, position in the DCI, etc.

In various implementations, the BS 102 may use one or more DCI signalings (e.g., one or two types of DCI signalings) to indicate the TDD configuration of the SN 306 (e.g., SN CU and/or SN FU). For example, the BS 102 can use one DCI signaling to indicate the TDD configuration of SN 306 (e.g., SN CU and/or SN FU). In this case, the DCI signaling may be a DCI format 2_0 with CRC scrambled by slot format indicator-radio network temporary identifier (SFI-RNTI), a new RNTI, and/or a new DCI format with CRC scrambled by a new RNTI, to name a few. The new RNTI may be or correspond to an SN-specific, link-specific, service type-specific, and/or SN logic unit/entity-specific RNTI (e.g., SN CU and/or SN FU-related RNTI).

In another example, the BS 102 may use two DCI signaling to indicate the TDD configuration of the SN CU and/or SN FU, respectively. The DCI signaling (e.g., a first DCI signaling) indicated for SN CU can be a DCI format 2_0 with CRC scrambled by SFI-RNTI and/or a new RNTI, and/or a new DCI format with CRC scrambled by a new RNTI. The new RNTI can be an SN-specific, link-specific, service type-specific, and/or SN logic unit/entity-specific RNTI (e.g., SN CU-related RNTI). Another DCI signaling (e.g., a second DCI signaling) indicated for SN FU can be a DCI format 2_0 with CRC scrambled by SFI-RNTI and/or a new RNTI, and/or a new DCI format with CRC scrambled by a new RNTI. The new RNTI may be an SN-specific, link-specific, service type-specific, and/or SN logic unit/entity-specific RNTI (e.g., SN FU-related RNTI).

In some cases, to enable the SN 306 to identify/determine whether the received DCI signaling is used for CU and/or FU, the two DCI signaling signals may have different DCI formats, are scrambled/included with different RNTIs, and/or have different DCI formats and scrambled with different RNTIs, such as referred to or described in conjunction with at least one of example configurations 2.1 to 2.5 of example implementation 2 discussed herein, for example.

### Example Implementation 2

In certain systems, a type (e.g., direction) of a symbol and/or a slot may be configured as downlink (DL), uplink (UL), and/or flexible via semi-static configuration (e.g., TDD-UL-DL-ConfigCommon, TDD-UL-DL-ConfigDedicated, etc.). The flexible symbols can refer to symbols other than the uplink symbols and/or the downlink symbols which can be explicitly configured via the semi-static configuration. However, for the SN 306, the flexible symbols may cause uncertainty regarding the behavior/characteristic of the SN FU. For instance, if the direction or behavior of flexible symbols is not further clarified, it may not be clear whether the SN 306 should forward/transmit uplink transmission to the BS 102, downlink transmission to the UE 104, and/or shut down/turn off/change the state of the SN FU. In some cases, the SN 306 may assume, without the further clarification, that the flexible symbols may be an error, for example. Therefore, the systems and methods of the technical solution discussed herein can further clarify the behavior of the SN FU.

In various implementations, for the flexible symbols based on the semi-static configuration (e.g., TDD-UL-DL-ConfigCommon and/or TDD-UL-DL-ConfigDedicated), the BS 102 may be configured to use a DCI signaling to indicate SN FU forwarding behavior/characteristic (e.g., direction, slot format, TDD configuration, etc.) over the symbol(s), such as performing a DL and/or a UL forwarding. For the certain/remaining flexible symbols not indicated as at least one of UL and/or DL via the DCI signaling, the SN FU may turn off/deactivate and/or may not forward the signal(s), for instance, signal(s) from the BS 102 to the UE 104 and/or from the UE 104 to the BS 102.

In some implementations, the DCI signaling indicated/provided to the SN 306 (e.g., SN CU) for configuring the SN FU can be a DCI format 2_0 with CRC scrambled by SFI-RNTI and/or a new RNTI, and/or a new DCI format with CRC scrambled by the new RNTI. The new RNTI can be an SN-specific, link-specific, service type-specific, and/or SN logic unit/entity-specific RNTI (e.g., SN or SN FU-related RNTI), which may be different from SFI-RNTI. The DCI signaling can indicate the directions of the flexible symbols in multiple carriers. The carriers may be configured and/or added to a carrier list, such as the carrier list configured for or associated with the SN FU.

In various arrangements, multiple types of DCI signalings can be used (e.g., two types of DCI signalings) for the BS 102 to indicate the slot format (e.g., TDD configuration, such as DL, UL, and/or flexible) of symbols (e.g., flexible symbols) at the SN CU side and/or SN FU side, respectively. The DCI signalings may have the same or different DCI formats, and/or the same or different scrambled RNTIs. The indication from the BS 102 via the two types of DCI signaling can include at least one of the following configurations:

Configuration 2.1: The first type of DCI signaling used for indicating the slot format of the SN CU can reuse/reprocess the legacy DCI format 2_0 with CRC scrambled by SFI-RNTI. The second type of DCI signaling used for indicating the slot format of the SN FU can reuse the legacy DCI format 2_0 with CRC scrambled by a new RNTI.

Configuration 2.2: The first type of DCI signaling used for indicating the slot format of the SN CU can reuse the legacy DCI format 2_0 with CRC scrambled by SFI-RNTI. The second type of DCI signaling used for indicating the slot format of the SN FU can have a new DCI format with CRC scrambled by a new RNTI.

Configuration 2.3: The first type of DCI signaling used for indicating slot format of SN CU can reuse the legacy DCI format 2_0 with CRC scrambled by a first new RNTI (e.g., SN CU-related RNTI). The second type of DCI signaling used for indicating the slot format of the SN FU can reuse the legacy DCI format 2_0 with CRC scrambled by a second new RNTI (e.g., SN FU-related RNTI).

Configuration 2.4: The first type of DCI signaling used for indicating the slot format of the SN CU can reuse the legacy DCI format 2_0 with CRC scrambled by a first new RNTI (e.g., SN CU-related RNTI). The second type of DCI signaling used for indicating the slot format of the SN FU can have a new DCI format with CRC scrambled by a second new RNTI (e.g., SN FU-related RNTI).

Configuration 2.5: The first type of DCI signaling used for indicating the slot format of the SN CU can have a new DCI format with CRC scrambled by a first new RNTI (e.g. SN CU-related RNTI). The second type of DCI signaling used for indicating the slot format of the SN FU can have a new DCI format with CRC scrambled by a second new RNTI (e.g., SN FU-related RNTI).

Additionally or alternatively, other configurations may be considered, utilized, or implemented for the various types of DCI signaling to indicate the behavior of the flexible symbols, for example.

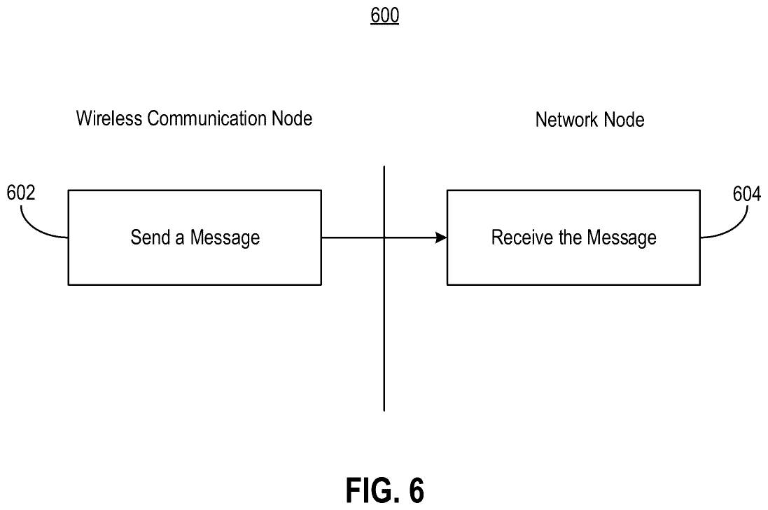

Referring now to FIG. 6 illustrates a flow diagram of a method 600 for TDD configurations for network nodes (e.g., SNs). The method 600 may be implemented using any of the components and devices detailed herein in conjunction with FIGS. 1-5. In overview, the method 600 may include sending a message (902). The method 600 can include receiving the message (904).

At operation (902), and in some arrangements, a wireless communication node (e.g., BS, gNB, eNB, or TRP) can send/transmit/provide/signal/communicate a message/signal to a network node (e.g., SN). At operation (904), and in some arrangements, the network node can receive the message from the wireless communication node. The message can be for a link (e.g., C-link and/or F-link) communicatively coupled between the network node and the wireless communication node and/or between the network node and a wireless communication device (e.g., UE). The message can include information, such as first information indicating one or more of time division duplex (TDD) configurations for the link and/or second information indicating one or more carriers for the link.

In various implementations, the link can include at least one of the following links: a first forwarding link (F-link) (e.g., backhaul link) from the wireless communication node to the network node (e.g., F2); a second forwarding link (e.g., backhaul link) from the network node to the wireless communication node (e.g., F1); a third forwarding link (e.g., access link) from the network node to the wireless communication device (e.g., F4); a fourth forwarding link (e.g., access link) from the wireless communication device to the network node (e.g., F3); a first control link (C-link) from the wireless communication node to the network node (e.g., C2); and/or a second communication link from the network node to the wireless communication node (e.g., C1).

In some implementations, the message can be received through/via a radio resource control (RRC) signaling. In this case, the RRC signaling may include a new RRC signaling and/or a legacy RRC signaling.

In some implementations, the message can be received through at least one of a medium access control control element (MAC CE) signaling and/or a downlink control information (DCI) signaling. The DCI signaling may include a single DCI signaling or multiple DCI signalings. The multiple DCI signalings may correspond to or include a first type and a second type. In some cases, the message can be received through a first type of DCI signaling and a second type of the DCI signaling that correspond to a first format and a second format, respectively. The first format and/or the second format (e.g., information or configuration) of the DCI signaling may be used for indicating the behavior/characteristic (e.g., direction) of a flexible symbol, for example.

In some implementations, the first format, associated with a first unit (e.g., CU) of the network node, can reuse a legacy DCI format with cyclic redundancy check (CRC) scrambled by a slot format indicator-radio network temporary identifier (SFI-RNTI), and the second format, associated with a second unit (e.g., FU) of the network node, can reuse the legacy DCI format with CRC scrambled by a new RNTI. In some implementations, the first format, associated with a first unit of the network node, can reuse a legacy DCI format with cyclic redundancy check (CRC) scrambled by a Slot Format Indicator-Radio Network Temporary Identifier (SFI-RNTI), and the second format, associated with a second unit of the network node, can have a new DCI format with CRC scrambled by a new RNTI.

In some implementations, the first format, associated with a first unit of the network node, can reuse a legacy DCI format with cyclic redundancy check (CRC) scrambled by a first new RNTI, and the second format, associated with a second unit of the network node, can reuse the legacy DCI format with CRC scrambled by a second new RNTI. In some implementations, the first format, associated with a first unit of the network node, can reuse a legacy DCI format with cyclic redundancy check (CRC) scrambled by a first new RNTI, and the second format, associated with a second unit of the network node, can have a new DCI format with CRC scrambled by a second new RNTI.

In some implementations, the first format, associated with a first unit of the network node, can have a first new DCI format with cyclic redundancy check (CRC) scrambled by a first new RNTI, and the second format, associated with a second unit of the network node, can have a second new DCI format with CRC scrambled by a second new RNTI. In some implementations, the legacy DCI format can be DCI format 2_0, among others.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A wireless communication method, comprising:
receiving, by a network node from a wireless communication node, a message for a link communicatively coupled between the network node and the wireless communication node or between the network node and a wireless communication device;
wherein the message comprises first information indicating one or more of Time Division Duplex (TDD) configurations for the link and/or second information indicating one or more carriers for the link.

2. The wireless communication method of claim 1, wherein the link comprises at least one of following links:
a first forwarding link from the wireless communication node to the network node;
a second forwarding link from the network node to the wireless communication node;
a third forwarding link from the network node to the wireless communication device;
a fourth forwarding link from the wireless communication device to the network node;
a first control link from the wireless communication node to the network node; or
a second communication link from the network node to the wireless communication node.

3. The wireless communication method of claim 1, wherein the message is received through a Radio Resource Control (RRC) signaling.

4. The wireless communication method of claim 3, wherein the RRC signaling includes a new RRC signaling or a legacy RRC signaling.

5. The wireless communication method of claim 1, wherein the message is received through at least one of a medium access control control element (MAC CE) signaling or a Downlink Control Information (DCI) signaling.

6. The wireless communication method of claim 5, wherein the DCI signaling includes a single DCI signaling or multiple DCI signalings.

7. The wireless communication method of claim 1, wherein the message is received through a first type of DCI signaling and a second type of DCI signaling that correspond to a first format and a second format, respectively.

8. The wireless communication method of claim 7, wherein the first format, associated with a first unit of the network node, reuses a legacy DCI format with cyclic redundancy check (CRC) scrambled by a Slot Format Indicator-Radio Network Temporary Identifier (SFI-RNTI), and the second format, associated with a second unit of the network node, reuses the legacy DCI format with CRC scrambled by a new RNTI.

9. The wireless communication method of claim 7, wherein the first format, associated with a first unit of the network node, reuses a legacy DCI format with cyclic redundancy check (CRC) scrambled by a Slot Format Indicator-Radio Network Temporary Identifier (SFI-RNTI), and the second format, associated with a second unit of the network node, has a new DCI format with CRC scrambled by a new RNTI.

10. The wireless communication method of claim 7, wherein the first format, associated with a first unit of the network node, reuses a legacy DCI format with cyclic redundancy check (CRC) scrambled by a first new RNTI, and the second format, associated with a second unit of the network node, reuses the legacy DCI format with CRC scrambled by a second new RNTI.

11. The wireless communication method of claim 7, wherein the first format, associated with a first unit of the network node, reuses a legacy DCI format with cyclic redundancy check (CRC) scrambled by a first new RNTI, and the second format, associated with a second unit of the network node, has a new DCI format with CRC scrambled by a second new RNTI.

12. The wireless communication method of claim 7, wherein the first format, associated with a first unit of the network node, has a first new DCI format with cyclic redundancy check (CRC) scrambled by a first new RNTI, and the second format, associated with a second unit of the network node, has a second new DCI format with CRC scrambled by a second new RNTI.

13. The wireless communication method of claim 8, the legacy DCI format is DCI format 2_0.

14. A wireless communication method, comprising:
transmitting, by a wireless communication node to a network node, a message for a link communicatively coupled between the network node and the wireless communication node or between the network node and a wireless communication device;
wherein the message comprises first information indicating one or more of Time Division Duplex (TDD) configurations for the link and/or second information indicating one or more carriers for the link.

15. A wireless communication node, comprising:
at least one processor configured to:
transmit, via a transmitter to a network node, a message for a link communicatively coupled between the network node and the wireless communication node or between the network node and a wireless communication device;
wherein the message comprises first information indicating one or more of Time Division Duplex (TDD) configurations for the link and/or second information indicating one or more carriers for the link.

16. A network node, comprising:
at least one processor configured to:
receive, via a receiver from a wireless communication node, a message for a link communicatively coupled between the network node and the wireless communication node or between the network node and a wireless communication device;
wherein the message comprises first information indicating one or more of Time Division Duplex (TDD) configurations for the link and/or second information indicating one or more carriers for the link.

17. The wireless communication method of claim 16, wherein the link comprises at least one of following links:
a first forwarding link from the wireless communication node to the network node;
a second forwarding link from the network node to the wireless communication node;
a third forwarding link from the network node to the wireless communication device;
a fourth forwarding link from the wireless communication device to the network node;
a first control link from the wireless communication node to the network node; or
a second communication link from the network node to the wireless communication node.

18. The wireless communication method of claim 16, wherein the message is received through a Radio Resource Control (RRC) signaling.

19. The wireless communication method of claim 18, wherein the RRC signaling includes a new RRC signaling or a legacy RRC signaling.

20. The wireless communication method of claim 16, wherein the message is received through at least one of a medium access control control element (MAC CE) signaling or a Downlink Control Information (DCI) signaling.
